(19) United States
(12) Patent Application Publication
(10) Pub. No.: US 2018/0070184 A1
(43) Pub. Date: Mar. 8, 2018

(54) SOUND COLLECTION EQUIPMENT HAVING A FUNCTION OF ANSWERING INCOMING CALLS AND CONTROL METHOD OF SOUND COLLECTION

(71) Applicant: Unlimiter MFA Co., Ltd., Eden Island, SC (US)

(72) Inventors: Kuo-Ping YANG, Taipei (TW); Neo Bob Chih-Yung YOUNG, Taipei (TW); Kuan-Li CHAO, Taipei (TW)

(21) Appl. No.: 15/375,325

(22) Filed: Dec. 12, 2016

(30) Foreign Application Priority Data
Sep. 5, 2016 (TW) 105128684

(51) Int. Cl. H04R 25/00; H04R 1/32

(52) U.S. Cl. CPC H04R 25/43; H04R 2225/55; H04R 1/32; H04R 25/554

(57) ABSTRACT

A sound collection equipment is disclosed. The sound collection equipment includes an earphone, a near microphone, a far microphone, a communication module and a control module. The far microphone is used for receiving a live voice message. The communication module is used for a voice message transmitted from a voice communication device. The control module is electrically connected to the earphone, the near microphone, the far microphone and the communication module. The control module controls the far microphone to collect sounds and controls the earphone to play the live voice message when the sound collection equipment does not communicate with the voice communication device. The control module controls the near microphone to collect sounds and controls the earphone to play the voice message when the sound collection equipment communicates with the voice communication device.

### BACKGROUND OF THE INVENTION

### 1. Field of the Invention

The present invention relates to a sound collection equipment; more particularly, the present invention relates to a sound collection equipment having a function of answering incoming calls.

### 2. Description of the Related Art

Nowadays, some hearing aids are equipped with the function of answering incoming calls and can be set to connect to the user's mobile phone. When there is an incoming call, the user can answer the phone via an earphone of the hearing aid and utilize a microphone of the hearing aid to talk to the caller.

However, in order to clearly hear the voice from the caller as well as to avoid being influenced by the user's own voice while the hearing aid is in use, the microphone is usually placed at a certain distance from the user's mouth. As a result, the user usually has to either move the microphone of the hearing aid toward the mouth or speak loudly when there is an incoming call so that the caller can clearly hear the user's voice, which is very inconvenient to the user.

Therefore, there is a need to provide a sound collection equipment having a function of answering incoming calls and a control method of sound collection to mitigate and/or obviate the aforementioned problems.

### SUMMARY OF THE INVENTION

It is an object of the present invention to provide a sound collection equipment capable of answering incoming calls.

It is another object of the present invention to provide a control method of sound collection for controlling a sound collection equipment having a function of answering incoming calls.

To achieve the abovementioned objects, the sound collection equipment having a function of answering incoming calls of the present invention can communicate with a voice communication device and receive a live voice message. The sound collection equipment comprises an earphone, a near microphone, a far microphone, a communication module and a control module. The far microphone is used for receiving a live voice message. The communication module is used for receiving a voice message transmitted from the voice communication device. The control module is electrically connected to the earphone, the near microphone, the far microphone and the communication module, wherein when the sound collection equipment does not communicate with the voice communication device, the control module controls the far microphone to collect sounds and controls the earphone to play the live voice message; and when the sound collection equipment communicates with the voice communication device, the control module controls the near microphone to collect sounds and controls the earphone to play the voice message.

To achieve another object, the control method of sound collection of the present invention is applicable to a sound collection equipment. The sound collection equipment is capable of communicating with a voice communication device and receiving a live voice message. The sound collection equipment comprises an earphone, a near microphone and a far microphone. The control method of sound collection comprises the following steps: detecting whether the sound collection equipment communicates with the voice communication device; if no, controlling the far microphone to collect sounds and controlling the earphone to play the live voice message; and if yes, controlling the near microphone to collect sounds and controlling the earphone to play a voice message transmitted from the voice communication device.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a structural drawing of a sound collection equipment having a function of answering incoming calls according to the present invention.

FIG. 2 illustrates a schematic drawing of the sound collection equipment having a function of answering incoming calls according to the present invention.

FIG. 3 illustrates a flowchart of a control method of sound collection. according to the present invention.

### DETAILED DESCRIPTION OF THE PREFERRED EMBODIMENT

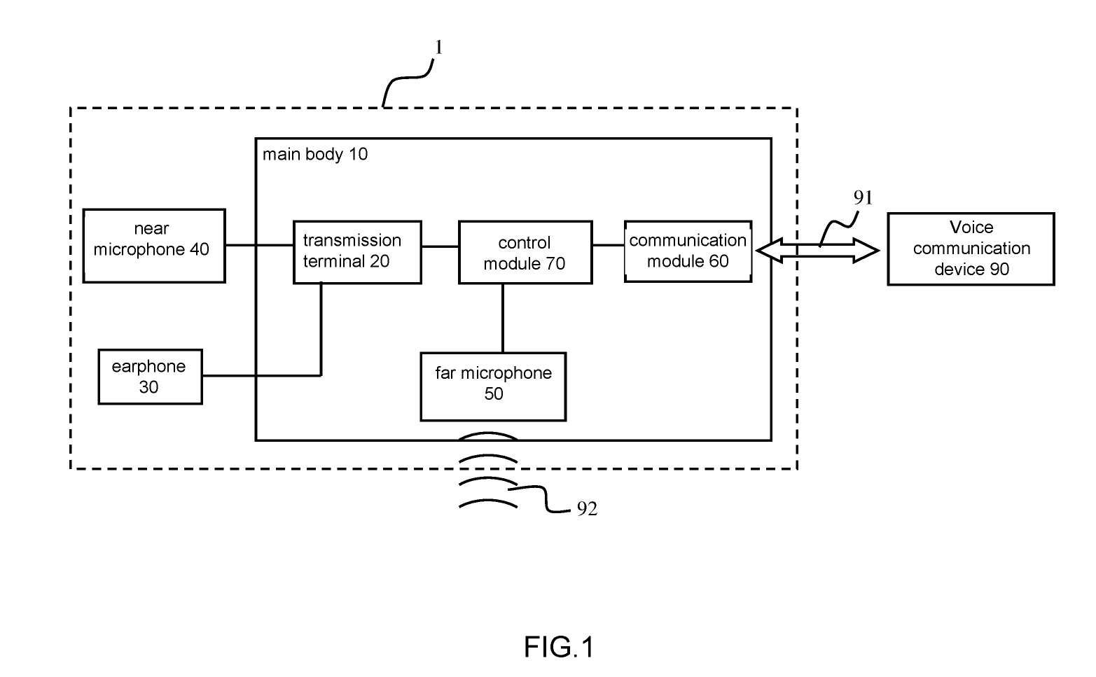

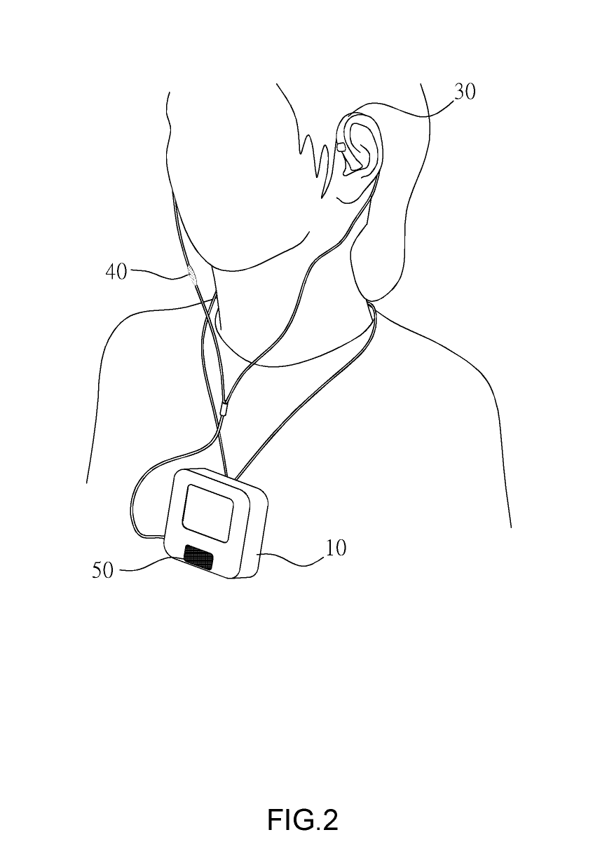

Please refer to FIG. 1 and FIG. 2, wherein FIG. 1. illustrates a structural drawing of a sound collection equipment having a function of answering incoming calls according to the present invention, and FIG. 2 illustrates a schematic drawing of the sound collection equipment having a function of answering incoming calls according to the present invention.

As shown in FIG. 1, in one embodiment of the present invention, the sound collection equipment 1 having a function of answering incoming calls of the present invention can communicate with a voice communication. device 90 so as to receive a voice message 91 transmitted from the voice communication device 90. Furthermore, the sound collection equipment 1 can also receive a live voice message 92, such as human speech sounds. In a specific embodiment of the present invention, the voice communication device 90 is, but is not limited to, a smart phone.

In one embodiment of the present invention, the sound collection equipment 1 comprises a main body 10, a transmission terminal 20, an earphone 30, a near microphone 40, a far microphone 50, a communication module 60 and a control module 70. In the embodiment of the present invention, the sound collection equipment 1 is, but is not limited to, a hearing aid.

In one embodiment of the present invention, the main body 10 is an equipment body, and the transmission terminal 20, the far microphone 50, the communication module 60 and the control module 70 are installed within the main body 10. The main body 10 is provided with at least one audio socket (not shown in figures) for a plug (not shown in figures) of the near microphone 40 and the earphone 30 to be inserted into, so as to connect to the transmission terminal 20, such that the near microphone 40 and the earphone 30 can be electrically connected to the control module 70 via the transmission terminal 20.

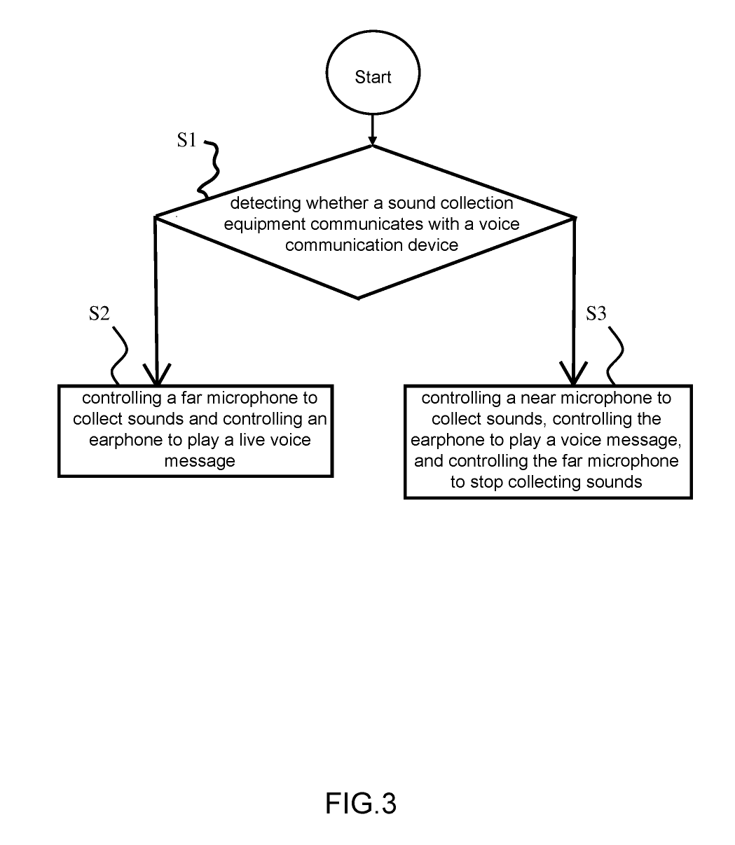

In one embodiment of the present invention, the far microphone 50 is electrically connected to the control module 70. The far microphone 50 is used for receiving the live voice message 92. As shown in FIG. 2 and FIG. 3, in the embodiment of the present invention, the distance between the far microphone 50 and the earphone 30 is greater than the distance between the near microphone 40 and the earphone 30. While in use, the near microphone 40 is closer to the user's mouth and thus can collect the user's speech sounds better than the far microphone 50 can.

In one embodiment of the present invention, the communication module 60 is electrically connected to the control module 70. The communication module 60 is used for executing communication operations so as to receive the voice message 91 transmitted from the voice communication device 90. In a specific embodiment of the present invention, the communication module 60 is a Bluetooth device which is capable of establishing a connection with a Bluetooth device of the voice communication device 90 for performing communications. However, the communication module 60 of the present invention is not limited to the Bluetooth device; the communication module 60 can also be a network card which performs communications with the voice communication device 90 via a wireless network (such as WiFi); or, the communication module 60 can be a universal serial bus (USB) device, which performs communications with the voice communication device 90 by way of inserting the USB device into a USB socket (not shown in figures) of the voice communication device 90.

In one embodiment of the present invention, the control module 70 can correspondingly control the far microphone 50, the near microphone 40 and the earphone 30 according to a communication status between the sound collection equipment 1 and the voice communication device 90. When the sound collection equipment 1 does not communicate with the voice communication device 90, the control module 70 controls the far microphone 50 to collect sounds and controls the earphone 30 to play the live voice message 92 received by the far microphone 50. When the sound collection equipment 1 communicates with the voice communication device 90, the control module 70 controls the near microphone 40 to collect sounds, controls the earphone 30 to play the voice message 91 transmitted from the voice communication device 90, and controls the far microphone 50 to stop collecting sounds.

For example, if no voice message 91 is generated by the voice communication device 90, the voice communication device 90 is determined not to be communicating with the sound collection equipment 1. At this time, in order that the user of the sound collection equipment 1 can clearly hear conversations with persons who are present in the user's immediate environment, the control module 70 will control the far microphone 50 to collect sounds. As a result, when a nearby person speaks, the far microphone 50 can collect the sounds, and the sounds received by the far microphone 50 can be played via the earphone 30.

If the voice communication device 90 receives an incoming call and generates a ringtone (i.e., the voice message 91), the voice communication device 90 will automatically connect to the sound collection equipment 1 to perform communications. After the connection is established, the generated voice message 91 will be transmitted to the sound collection equipment 1. At this time, in order that the caller can clearly hear the voice of the user of the sound collection equipment 1, the control module 70 will control the near microphone 40 to collect sounds and control the earphone 30 to play the voice message 91 transmitted from the voice communication device 90. After the user answers the incoming call after hearing the ringtone via the earphone 30, the user can hear the caller's voice (i.e., the voice message 91). The user's voice can be collected by the near microphone 40, transmitted to the voice communication device 90, and further transmitted to the caller's voice communication device (such as a mobile phone).

Finally, please refer to FIGS. 1-3, wherein FIG. 3 illustrates a flowchart of a control method of sound collection according to the present invention. FIG. 1 and FIG. 2 are used as references for sequentially explaining the steps shown in FIG. 3. The sound collection equipment 1 as disclosed in FIG. 1 is only provided as one example for explaining the control method of sound collection of the present invention without limiting the scope of the present invention.

As shown in FIG. 1 and FIG. 3, first, the method performs step S1: detecting whether a sound collection equipment communicates with a voice communication device.

The control method of sound collection of the present invention can correspondingly control the earphone 30, the near microphone 40 and the far microphone 50 of the sound collection equipment 1 according to the communication status between the sound collection equipment 1 and the voice communication device 90. Therefore, the first step of the method is that the control module 70 of the sound collection equipment 1 detects whether the sound collection equipment 1 communicates with the voice communication device 90.

Then the method performs step S2: controlling a far microphone to collect sounds and controlling an earphone to play a live voice message.

After step S1, if the control module 70 does not receive a signal from the voice module 60, the control module 70 will determine that the sound collection equipment 1 does not communicate with the voice communication device 90. At this time, the control module 70 will control the far microphone 50 to collect sounds and control the earphone 30 to play the live voice message collected by the far microphone 50.

Step S3: controlling a near microphone to collect sounds, controlling the earphone to play a voice message, and controlling the far microphone to stop collecting sounds.

In contrast, if the communication module 60 of the sound collection equipment 1 receives a voice message 91 transmitted from the voice communication device 90, the control module 70 will determine that the sound collection equipment 1 communicates with the voice communication device 90. At this time, the control module 70 will control the near microphone 40 to collect sounds, control the earphone 30 to play the voice message 91, and meanwhile control the far microphone 50 to stop collecting sounds.

According to the above description, the sound collection equipment 1 having a function of answering incoming calls and the control method of sound collection disclosed by the present invention can correspondingly adjust the sound collection of microphones and the playback of the earphone according to the communication status between the sound collection equipment 1 and the voice communication device 90. On one hand, when the user talks to another person face-to-face, the far microphone 50 closer to the other person can collect sounds such that the user can clearly hear the other person's voice; on the other hand, if an incoming call activates the voice communication device 90, the near microphone 40 closer to the user's mouth can collect sounds such that the caller can clearly hear the user's voice.

Although the present invention has been explained in relation to its preferred embodiments, it is to be understood that many other possible modifications and variations can be made without departing from the spirit and scope of the invention as hereinafter claimed.

1. A hearing aid having a function of answering incoming calls, capable of communicating with a voice communication device and receiving a live voice message, the hearing aid comprising:
an earphone;
a near microphone;
a far microphone, used for receiving the live voice message;
a communication module, used for receiving a voice message transmitted from the voice communication device; and
a control module, electrically connected to the earphone, the near microphone, the far microphone and the communication module;
wherein when the hearing aid does not communicate with the voice communication device, the control module controls the far microphone to collect sounds and controls the earphone to play the live voice message; and
when the hearing aid communicates with the voice communication device, the control module controls the near microphone to collect sounds and controls the earphone to play the voice message, and further controls the far microphone to stop collecting sounds.

2. The hearing aid as claimed in claim 1, wherein when the sound collection equipment communicates with the voice communication device, the control module further controls the far microphone to stop collecting sounds.

3. The hearing aid as claimed in claim 1, further comprising a main body with the communication module and the control module disposed therein.

4. The hearing aid as claimed in claim 3, wherein the far microphone is disposed in the main body, and the near microphone is disposed outside the main body.

5. The hearing aid as claimed in claim 1, wherein the distance between the far microphone and the earphone is greater than the distance between the near microphone and the earphone.

6. The hearing aid as claimed in claim 2, wherein the distance between the far microphone and the earphone is greater than the distance between the near microphone and the earphone.

7. A control method of sound collection, applicable for a hearing aid, the sound collection equipment being capable of communicating with a voice communication device and receiving a live voice message, wherein the hearing aid comprises an earphone, a near microphone and a far microphone, the control method of sound collection comprising the following steps:
detecting whether the hearing aid communicates with the voice communication device;
if no, controlling the far microphone to collect sounds and controlling the earphone to play the live voice message; and
if yes, controlling the near microphone to collect sounds and controlling the earphone to play a voice message transmitted from the voice communication device, and controlling the far microphone to stop collecting sounds.

8. (canceled)

9. The control method of sound collection as claimed in claim 7, wherein the distance between the far microphone and the earphone is greater than the distance between the near microphone and the earphone.

10. The control method of sound collection as claimed in claim 7, wherein the distance between the far microphone and the earphone is greater than the distance between the near microphone and the earphone.
